(19) United States
(12) Patent Application Publication
(10) Pub. No.: US 2020/0257934 A1
(43) Pub. Date: Aug. 13, 2020

(54) PROCESSING CONTENT

(71) Applicant: QUBEEO Ltd., Brighton, East Sussex (GB)

(72) Inventors: Janet Bastiman, Brighton (GB); Matt Bastiman, Brighton (GB); Edward Grant, Brighton (GB); Ricardo Guerrero, Brighton (GB)

(21) Appl. No.: 16/647,239

(22) PCT Filed: Sep. 14, 2018
(86) PCT No.: PCT/EP2018/074915

§ 371 Date: Mar. 13, 2020

(30) Foreign Application Priority Data
Sep. 15, 2017 (GB) 1714881.8

(51) Int. Cl. G06K 9/62

(52) U.S. Cl. CPC G06K 9/6251; G06K 9/6218

(57) ABSTRACT

A computer-implemented method of processing content items to extract information for analysis at a data processing stage, including receiving the content items, executing a plurality of probabilistic classifiers for analyzing the content items in relation to a plurality of predetermined criteria, processing each of the content items using the probabilistic classifiers to generate a corresponding multidimensional feature vector, each dimension of the feature vector corresponding to one of the predetermined criteria and having a value determined by one of the probabilistic classifiers, denoting a probability that the content item meets that criterion, applying cluster analysis to the multidimensional feature vectors to identify a plurality of clusters of the multidimensional feature vectors, and extracting, for analysis, information about each of the clusters from at least one of the feature vectors in that cluster and/or the content item to which it corresponds.

### TECHNICAL FIELD

This disclosure relates to the processing of content at a data processing stage to extract information for analysis.

### BACKGROUND

The proliferation of content, such as internet content, presents challenges in the context of analytics. For example, content publishers such as social media platforms publish overwhelmingly large amounts of user generated content every day, with one of the most popular social media platforms alone publishing around 300 million new photo uploads per day. These large and complex content or data sets contain a wealth of useful information. However, much of this information is hidden in the sense that it is difficult or impossible to extract it using traditional data processing software and impossible for humans to extract it manually in practice, due to the volume of data but also the effects of human bias.

### SUMMARY

A first aspect of the invention provides a computer-implemented method of processing content items to extract information for analysis, the method comprising implementing, at a data processing stage, the following steps: receiving the content items to be processed, wherein a plurality of probabilistic classifiers is executed at the data processing stage for analyzing the content items in relation to a plurality of predetermined criteria; processing each of the content items, by the probabilistic classifiers, so as to generate a corresponding multidimensional feature vector, wherein each dimension of the feature vector corresponds to one of the predetermined criteria and has a value, determined by one of the probabilistic classifiers, which denotes a probability that the content item meets that criterion; applying cluster analysis to the multidimensional feature vectors at the data processing stage to identify a plurality of clusters of the multidimensional feature vectors; and extracting, for analysis, information about each of the clusters from at least one of the feature vectors in that cluster and/or the content item to which it corresponds.

A key innovation is that the content items are classified probabilistically, by the probabilistic classifiers, in order to generate the multidimensional feature vectors, that are then subject to cluster analysis. That is, the probabilistic classification is performed before the cluster analysis, and the output of the probabilistic classification is used as an input to the cluster analysis. This innovative technique has proved highly successful in identifying hidden groupings and trends in a set of content items that is would be impossible or impractical to identify using existing data processing techniques.

It is known to use cluster analysis to build classifiers. For example, nearest centroid classification applies k-means clustering to training vectors to identify a set of clusters, and uses the centroids of the clusters, once identified from the training data, to classify other feature vectors. However, generating the feature vectors themselves using probabilistic classifiers, i.e. using the output of a set of probabilistic classifiers as an input to the cluster analysis, is believed to be novel. The output of each classifier can be a softmax output, such that each feature vector corresponds to a concatenation of softmax outputs from the classifiers.

A key feature of the resulting feature vectors is that each feature vector dimension corresponds a probability that a different tangible, predetermined criterion is met. For example, when applied to image data, the value of a feature vector dimension can correspond to the probability that a particular type of object or other “thing” (element), such as colour, sentiment etc., is present, with different feature vector dimensions corresponding to different types of object/image element.

The present techniques are not, however, limited to image data, and can be applied to content items containing any type of content. Indeed, another benefit of the techniques is that they can be applied to a set of content items where different ones of the content items contain different types of content (e.g. image, video, text, audio, user/demographic data etc.), and/or where some or all of the content items contain a combination of different types of content. With such “mixed” content items, the resulting feature vectors have values generated using different types of analysis, such as a combination of image or audio recognition and natural language processing.

In embodiments, the step of applying the cluster analysis comprises: applying a clustering algorithm executed at the data processing stage to the feature vectors to identify an initial set of clusters of the feature vectors; for at least a first cluster of the initial set of clusters, identifying at least one dominant dimension of the feature vectors in the first cluster; and re-applying the clustering algorithm to the feature vectors in the first cluster, with the at least one dominant dimension suppressed or removed, to identify at least two sub-clusters of the feature vectors in the first cluster; wherein the extracted information comprises information about at least one of the sub-clusters extracted from at least one feature vector in the sub-cluster and/or the content item to which it corresponds.

In embodiments, the steps of identifying the at least one dominant dimension and re-applying the clustering algorithm are performed in response to determining that the number of feature vectors in the first cluster exceeds a maximum threshold.

In embodiments, the maximum threshold is determined as a percentage of the total number of feature vectors to which the cluster analysis is applied.

In embodiments, at least one of the content items comprises image data and at least one of the predetermined criteria is an image-related criterion, wherein the value of the corresponding dimension of the feature vector for the content item comprising the image data is determined by applying image recognition to the image data and denotes a probability that the image data meets the image-related criterion.

In embodiments, multiple ones of the predetermined criteria are image-related criteria, wherein the values of the corresponding dimensions of the feature vectors for the content item comprising the image data are determined by applying respective image recognition to the image data and denote respective probabilities that the image data meets the respective predetermined image-related criteria.

In embodiments, the or each image-related criterion relates to a predetermined object, structure, colour, colour scheme or sentiment, wherein the value denotes a probability that the image data contains the predetermined object, image structure, colour or colour scheme or expresses the predetermined sentiment.

In embodiments, at least one of the content items comprises a combination of at least two different types of content, wherein respective content processing is applied to each of the types of content to determine the corresponding feature vector.

In embodiments, the at least one content item comprises at least two of: text data, image data, video data, audio data, engagement data and user data.

In embodiments, information is not extracted from any clusters containing less than a minimum number of feature vectors.

In embodiments, the method further comprises steps of: using the extracted information to identify at least one feature vector dimension to be suppressed or removed; at the data processing stage, applying further cluster analysis to the feature vectors, with the identified dimension suppressed or removed, to identify at least one additional cluster of the feature vectors which was not identified in performing the cluster analysis; and at the data processing stage, extracting, for analysis, information about the additional cluster from at least one feature vector in the additional cluster and/or the content item to which it corresponds.

In embodiments, each of the feature vector dimensions has a label, held in electronic storage, which indicates the predetermined criteria to which it corresponds; wherein the step of extracting the information about the at least one cluster comprises identifying at least one dominant dimension of the feature vectors in that cluster, and determining at least one cluster label using the electronically stored label of the at least one dominant dimension, the extracted information comprising the at least one cluster label.

In embodiments, the step of extracting the information about the at least one cluster comprises identifying at least two dominant dimensions of the feature vectors in that cluster, and determining the cluster label by combining the labels of the at least two dominant dimensions.

The label may be a natural language label. For example, the determined cluster label may be selected according to one or more predetermined language rules. For example, the language rules require the label to contain: an adjective and noun combination; or a noun and noun combination.

In embodiments, the step of extracting the information about the at least one cluster comprises selecting one of more of the content items having feature vectors in that cluster based on engagement data associated with the content items, wherein the extracted information comprises content extracted from those content items.

In embodiments, the information about the at least one cluster comprises a colour palette, identifying a set of most commonly occurring colours in the content items in the cluster.

In embodiments, the extracted information comprises at least one of: a count of content items in the cluster, and indication of the relative size of the cluster.

In embodiments, the method further comprises a step of controlling a display device to display the extracted information to a user.

In embodiments, wherein each of the probabilistic classifiers generates a softmax output. For example, each of the feature vectors may correspond to a concatenation of the softmax outputs of the probabilistic classifiers.

According to a second aspect disclosed herein, there is provided a data processing stage for processing content items to extract information for analysis, the data processing stage comprising: an input for receiving content items to be processed; and processing apparatus configured to execute a plurality of probabilistic classifiers for analyzing the content items in relation to a plurality of predetermined criteria, wherein the data processing stage is configured to apply, to the received content items, any of the method steps disclosed herein.

According to a third aspect disclosed herein, there is provided a system for selecting and processing content items, the system comprising: a content selection interface configured to receive from a content-selecting user at least one content selection parameter; a content selection component configured to select, from content items published on a content publication platform, a set of the published content items satisfying the at least one content selection parameter; and a data processing stage configured to apply the steps of any of the method steps disclosed herein to the selected set of content items.

In embodiments, the content publication platform is a social media platform.

In embodiments, the content selection component is configured to select the set of content items from multiple content publication platforms.

In embodiments, the system comprises a display device configured to display the extracted information to a user.

In embodiments, the display device is a user device operated by the content-selecting user, the content selection parameter being inputted by the content-selecting user at the user device for receiving at the content selection interface.

Another aspect of the invention provides a computer-implemented method of processing content items to extract information for analysis, the method comprising implementing, at a data processing stage, the following steps: analysing each of the content items to generate a corresponding multidimensional feature vector, wherein the data processing stage is operable to generate the multidimensional feature vectors for content items comprising a combination of image or video and text data by applying image recognition to the image or video data and natural language processing to the text data, applying cluster analysis to the multidimensional feature vectors to identify a plurality of clusters of the multidimensional feature vectors, and extracting, for analysis, information about each of the clusters from at least one of the feature vectors in that cluster and/or the corresponding content item.

Text and image/video is an important use-case, however it is just one example. The same technique can be applied to other data (e.g. audio, video, purchase history etc.), and in general the same technique can be applied to any combination of data types, such as two or more of: audio data, image data, video data, text data, user data (demographics, purchase history etc.).

### BRIEF DESCRIPTION OF THE DRAWINGS

To assist understanding of the present disclosure and to show how embodiments may be put into effect, reference will be made by way of example to the accompanying drawings in which:

FIG. 1 is a schematic block diagram of a content processing system;

FIG. 2 is a schematic diagram of a content item;

FIG. 3 is a schematic function block diagram for a data processing stage, configured to perform an analytic process on a set of content items to extract information for analysis;

FIGS. 4a and 4b gives a high-level overview of predetermined criteria that can be used to classify a content item in order to determine a corresponding multidimensional feature vector;

FIG. 5 shows the results of a principal component analysis applied to a set of classified feature vectors determined for a set of content items; and

FIG. 6 shows one example of how information extracted at a data processing stage from an identified cluster can be structured for the purposes of analysis.

### DETAILED DESCRIPTION OF EMBODIMENTS

Embodiments of the invention will now be described, in which a set of content items is collected from one of more content publication platforms according to one or more content-selection parameters provided by a user, and analytics are performed on the set on the set of content items using advanced AI (artificial intelligence) processing, to identify hidden groupings and trends within the set of content items.

To perform the analytics, a multidimensional feature vector is determined for each content item in the set. The multidimensional feature vector has a large number of dimensions—at least one thousand in the described examples. Each of the dimensions corresponds to a tangible and predetermined criterion, such as the content item containing a predetermined image structure or other predetermined image content, expressing a certain sentiment, relating to a particular topic (which may not be identified explicitly in the content item) etc. In other words, for image data, a dimension can be the probability of the presence of a specific object (e.g. cat) or scene (e.g. office) in an image, or a dimension can be the amount of presence of a specific element found in an image e.g. the proportion of the colour red, the proportion of positivity of the post, etc. Furthermore, the predetermined criteria may be user defined. Different criteria can be used in different contexts, and different criteria can be used depending on the type of input.

Any combination of different criteria can be used, applied to one or more types of content. It may also be appropriate, in certain circumstances, to tailor the criteria to type of information that a user wants to extract,

The value of each dimension of each feature vector is determined by a probabilistic classifier, and denotes a probability that the content item satisfies the corresponding criterion. Accordingly, each 1000+ dimensional feature vector carries a wealth of information about the corresponding content item, relating to 1000+ different predetermined criteria.

Cluster analysis is then applied to the 1000+ dimensional feature vectors, which in the described examples is an iterative process in which k-means clustering (Lloyd's algorithm) is applied, with certain feature vector dimensions selectively suppressed or removed based on the results of the previous iteration. The aim is to identify hidden clusters that are sufficiently large to be significant (that is, which contain at least a minimum number of feature vectors, such as 5% of the total), whilst eliminating clusters that are “uninteresting” in the sense that they only provide any information could easily be derived from the cluster via less sophisticated computer processing or observation by a human.

One consideration in identifying uninteresting clusters is the size of the cluster, as clusters that are excessively large (containing more than a maximum number of feature vectors, such as 50% of the total) tend not to provide interesting information. On that basis, clusters containing more than the maximum number of feature vectors may be “broken up” automatically, by removing or suppressing the most dominant feature vector in that cluster—which is not necessarily the most dominant dimension in the other identified cluster(s)—and re-clustering those feature vectors to identify two or more sub-clusters, from which interesting information can be extracted (or which may need to be broken up further to allow the extraction of information).

Other considerations also apply, which may make it appropriate to remove or suppress certain dimensions across the whole corpus of content items, for example. Examples of this are described later. Preferably, this is an entirely automated AI process, however a degree of manual oversight and control may be appropriate in certain circumstances (at least as an interim measure when building a complex system).

Once the final set of clusters has been identified at the end of the iterative process, dominant dimensions are used again—this time to extract the information to be provided to the user for analysis. Mapping the dominant dimensions in a given cluster back to the corresponding subset of predetermined criteria provides rich information about the content items in that cluster; and by identifying dimensions that are uniquely dominant in a given cluster (i.e. in that cluster, but not in other clusters), it is possible to infer characteristics that are unique to that cluster.

A data processing stage, in the form of a computer system (comprising one or more processing units, such as CPUs and/or GPUs), is provided to perform the necessary processing once the content has been collected. The described image processing may be performed predominantly by GPUs, where appropriate.

Content Selection:

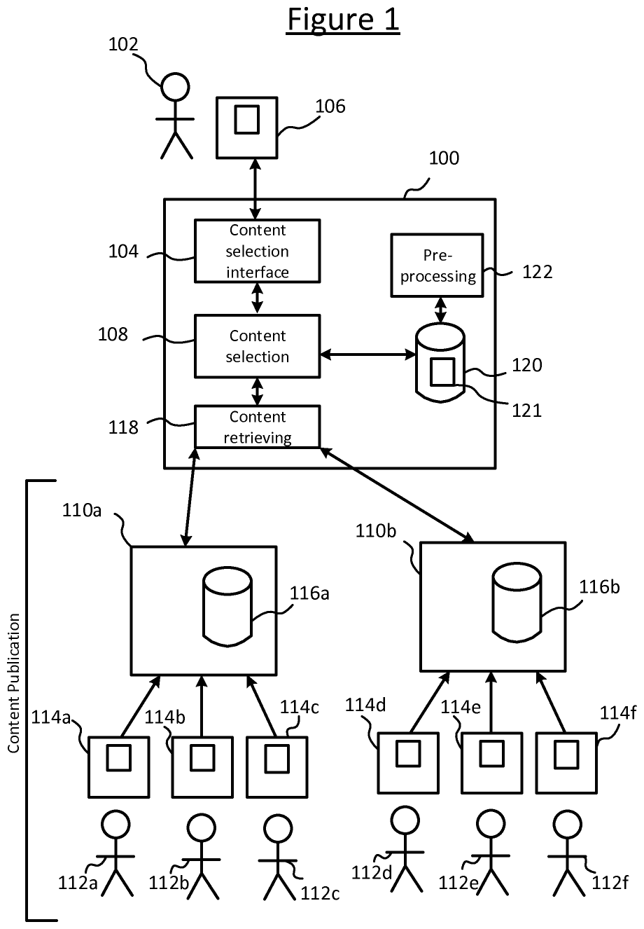

FIG. 1 shows a system 100 (content processing system) for collecting (pulling) and processing social media content from content publication platforms, such as social media platforms. The collected content can be used for various purposes, such as allowing a user to display a selection of the collected media content on their own website. For example, a car manufacturer may collect and display social media posts relating to their cars.

Another important use-case is analytics, which is the focus of this disclosure. Here, the system processes the collected content to extract useful information, which can be provided to the user for analysis (e.g. in the form of an electronic report). Examples of this are described later.

A user 102 (content selecting user) is able to search for content which can include, for example, a user-specified keyword or hashtag in social media posts. The user can select where said keyword should appear, i.e. in the user's name, in the social media post itself or in the comments from other users 112. Content items comprising image data can also be pulled based on one or more image-related criteria, for example. Other examples of content selection parameters, according to which content may be selected, are described later.

FIG. 1 shows schematically the system 100 for selecting content items from one or more social media platforms. A content-selecting user 102 may provide an input to a content selection interface 104 via a first user device 106. The first user device 106 may be, for example, a mobile user terminal such as a smartphone, tablet, laptop or other computing device. The input is in the form of a content selection parameter or a set of content parameters, according to which the system is to select items of content from the social media platforms. The content selection parameter(s) is received by a content selection component 108 of the system 100, e.g. via a network such as the Internet. The content selection component 108 is configured to select and retrieve content items from one or more social media platforms 110 according to the content selection parameter(s) provided by the user 102. The process of selecting and retrieving content items from a plurality of social media platforms 110 will be described in further detail below.

FIG. 1 shows two social media platforms 110a, 110b, however it is possible to select and retrieve content items from more than two social media platforms or a single social media platform 110. Users of a social media platform, such as users 102a-c and 112d-f of platforms 110a and 110b respectively, are referred to as social users herein, in contrast to the content-selecting user 102 who need not be a social media user at all (he may or may not happen to be).

A social media platform 110 may be, for example, a social networking site, a discussion forum, an image sharing site, etc. Examples of social media platforms include Facebook, Twitter, Instagram and Pinterest, among others. The term “social media platform” refers herein to a platform for publishing content, such that users of the platform can engage in social interactions by publishing content on the platform for consumption by the users, and consuming content published by other users on the platform. A content item refers to an individual item of content published on the platform, such as a post, article, comment, tweet, etc.

Other forms of content publication platform, such as blogs or a news sites, are also within the scope of this disclosure, and all description pertaining to social media platforms applies equally to other forms of content publication platform.

Content to be published, such as images, text, audio clips and videos (or combinations thereof) are provided or indicated to a given social media platform 110 from a plurality of social users 112, and published as content items that can be consumed by other social users. A content item can also contain a combination of different types of content, such as text and image/video data. An important feature of the described system is its ability to handle different types of content item comprising one or more types of content. That is, content items comprising different types of content or different combinations of content types. Each social user 112 may upload content for publication to a social media platform 110 via a respective second user device 114. Each respective second user device 114 may be, for example, a mobile user terminal such as a smartphone, tablet, laptop or other computing device. For example, social user 112a may upload content to a first social media platform 110a via second user device 114a. E.g. a social user 112 may upload a photograph to an image sharing site such as Instagram from their mobile phone.

The social media platforms 110a, 110b stores content items published on that platform in first and second databases—116a, 116b respectively. That is, the first social media platform 110a (e.g. Facebook) stores content uploaded from social users 112a, 112b, 112c as published content items in the first database 116a. The second social media platform 110b (e.g. Twitter) stores content uploaded from social users 112d, 112e, 112f as published content items in the second database 116b. Whilst FIG. 1 shows only six social users 112, each social media platform 110 may receive and store content items from a greater number of social users 112—potentially a very large number of users for popular platforms.

Each respective database may be stored on a server or (more commonly for large social media platforms) a network of servers, which may be geographically distributed e.g. in different data centres. In this respect, it is noted that the term “database” as used herein covers any ordered collection of stored data, including distributed databases.

Content items are selected and retrieved (e.g. pulled) from the one or more social media platforms 110 via a content retrieving component 118 of the system 100 based on the content selection parameter(s) defined by the content-selecting user 102. For example, only content items matching criteria defined by the content selection parameter(s) may be pulled from a social media platform 110. The content selection parameter may, for example, comprise a word or phrase such as a brand name or hashtag. For example, the content selection parameter may be the make and/or model of a motor vehicle. Further examples of a content selection parameter will be provided below. The user 102 can specify which social media platform or platforms he wants to pull content from.

Copies of content items retrieved from the one or more social media platforms 110 are stored in a content database 120 of the content processing system 100. A pre-processing component 122 is configured to convert the plurality of content items to an appropriate format for further analysis, such that they can be processed by a data processing stage of the system that is described later.

When searching for e.g. a car brand, hundreds (or even thousands) of different social media posts may be collected by the system 100. Optionally, the user 102 may be provided with options for narrowing down (filtering) the posts which have been collected. For example, the user 102 can select to include only social media posts with a user-defined minimum amount of likes, views, retweets, shares, etc. The posts can also be sorted and refined based on these criteria to create a shortlist. The social media posts may also be filtered by language, country of origin and posting time.

The shortlist of filtered social media posts may be approved by the user 102 or the user 102 can choose to include any posts that fulfil a set of criteria.

The filtering can also be automated, for example using image recognition techniques and natural language processing to provide a filtered shortlist to be analysed.

In the context of analytics, various considerations may be applicable when it comes to selecting an appropriate set of content items to analyse. Some form of manual and/or automatic filtering of the content items after they have been pulled from the platform(s) may be beneficial in certain circumstances, but is not essential.

Analytics:

A core piece of the analytics is a method of grouping a collection of social data by modelling all text and images in n-dimensional space using a softmax output of an image recognition artificial intelligence (AI) and several probabilistic outputs of natural language processing AI as a Euclidean vector-space coordinate set. This coordinate set is then grouped by k-means (Lloyd's Algorithm) clustering in the n-dimensional space, where n is a high dimensionality—at least one thousand in the described examples.

The softmax function is known per se, and represents one way of configuring the output of a probabilistic classifier. A probabilistic classifier is an AI classifier which evaluates an item in relation to one or more predetermined criteria (each corresponding to a “category”). For each of the predetermined criteria, the probabilistic classifier determines a probability that the item meets that criteria, or equivalently the probability that it falls in the corresponding category.

The softmax output provides a probability distribution over all of the categories evaluated by that classifier, as a probability vector, which can be a softmax output.

As the clusters are naturally generated from n-dimensional space, unwanted or noisy attributes can be removed simply by removing or shrinking (suppressing) a given dimension. Conversely dimensions can be grown if they are more interesting. This has been outlined above, and described in more detail below.

FIG. 2 shows schematically an example content item 202.

As shown, a content item 202 from a given social media platform 110 may contain one or more types of content, such as images 204, text 206, user data 208, engagement data 210, metadata 212, etc. For example, the image may be a photograph captured by a second user 112 of the first social media platform 110a, e.g. a landscape photograph. In another example, the image may contain architecture, one or more persons, food, animals, vehicles, etc.

In examples, the text 206 of the content item 202 may be entered by a first social user 112a who posted the content item 202 to the first social media platform 110a. For example, the text 206 may serve as a description of the image 204 or may be entered to show the thoughts and/or feelings of the social user 112a that accompany the image 204. In addition, the text 206 may contain user-entered text from a second social user 112b who did not create the content item 202, but who is also a user of the social media platform 110a such as a comment or reply etc. For example, the text 206 may be a comment made in relation to an image 204 within the content item 202. It is also common for users to include hashtags or other tags in content items, which can be used as a basis for selecting content.

In another example, the text 206 may be a part of the image 104 itself. For example, the image may contain a logo or brand name.

In examples, the user data 208 may comprise a profile or username of the first social user 112a. The username may uniquely identify the first social user 112a within the first social media platform 110a. In some examples, the user data 208 may comprise a profile picture set by the first social user 112a. The user data 208 can also comprise behavioural data, such as a user's purchase history.

In examples, the engagement data 210 may indicate the level of engagement with the content item 202 from other social users 112 of the first social media platform 110a. For example, the engagement data 210 may contain one or sentiment indicators such as a “like” or “dislike” option. In another example, the engagement data 210 may indicate how many times the content item 202 has been shared, quoted or retweeted by other social users 112 of the first social media platform 110a.

Content items can contain different types of content or combinations of different types of content. For example, the content item 202 may comprise more than one image 204. As another example, the content item 202 may additionally or alternatively comprise video or audio data.

The metadata 212 may for example comprise a time at which the content item 202 was posted on the first social media platform 110a and/or a location from which the content item 202 was posted. For example, the location may correspond to a geographical location of the respective second user device 114a of the first social user 112a used to post the content item 202 to the first social media platform 110a.

As mentioned above, a content selection parameter is provided to a content selection interface 104 by a content-selecting user 102. The content selection parameter may comprise, for example, a word, a phrase, a brand name, an object name, a location, etc.

The content selection parameter is used by the content selection component 108 to identify a set of content items 202 from one or more social media platforms 110 that satisfy the content selection parameter.

For example, to satisfy the content selection parameter, a content item 202 may comprise the content selection parameter. For example, if the content selection parameter was the word “Porsche”, a content item 202 that satisfies the content selection parameter may comprise the word “Porsche” in the image 204, user data 208 or text 206 of the content item 202. For images, the parameter may also be satisfied by an image containing structure recognised as a Porsche.

Social users are creating content at ever increasing rates. In 60 seconds, users collectively upload 400 hours of YouTube videos, 55,000 Instagram posts, 422,000 tweets and 3,300,000 Facebook posts. The system described herein allows content selection users (e.g. brands) to see their audience in a new way. The system uses probabilistic classification techniques to analyse social media imagery and the like to find hidden “tribes” in their audience referred to herein as “social tribes”. This new approach to audience segmentation helps to create more targeted, optimised and engaging content that will convert more users.

Every single social media post contains a wealth of data about audiences but advanced analytics are needed to update interesting, and often hidden data, from a large mixture of social media posts. Using techniques such as visual recognition and machine learning algorithms, the system analyses social posts to extract these hidden data points. The system can “read” the image and establish the context of the content, enhancing with data from text, demographic data and engagement metrics. This unique approach can be scaled up across thousands of posts across multiple social media channels. Using advanced algorithms, hidden groupings and trends in the data can be identified to reveal unique social tribes. Each social tribe corresponds to a cluster identified using unsupervised machine learning, as described below.

The system can produce detailed insight reports for each tribe detailing who they are, where you can find them and the content that they engage with.

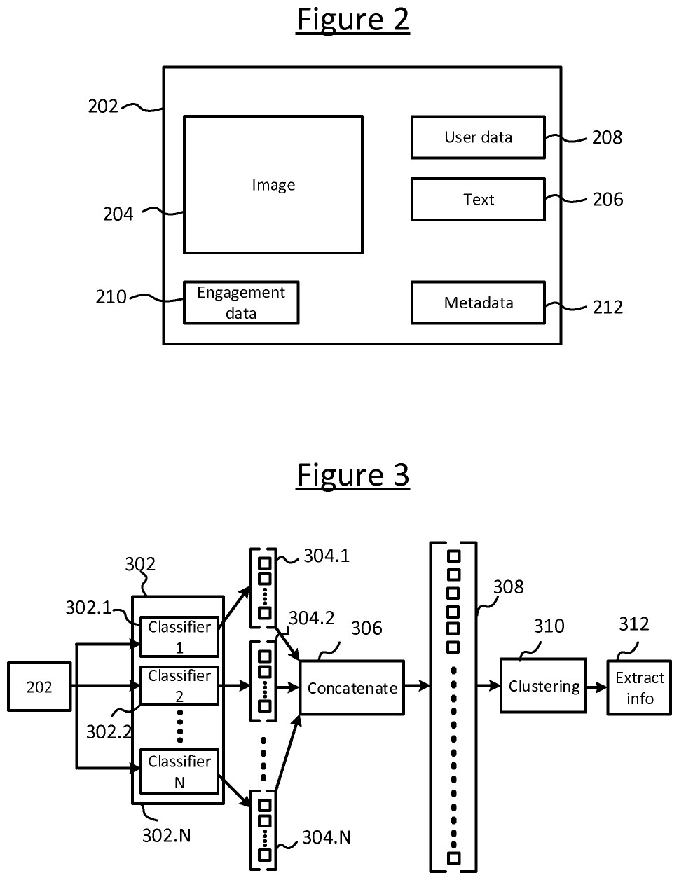

FIG. 3 shows schematically an analytic process performed on a plurality of retrieved content items from one or more social media platforms 110 of FIGS. 1 and 2, as well as the functional components of the data processing stage that perform the analysis. Components 302, 306, 310 and 312 described below, are functional components of a data processing stage of the system 100.

Probabilistic classification techniques are applied to one or more content items 202 identified by the content selection parameter and retrieved by the content retrieving component. This is shown schematically in FIG. 3, wherein a set of N bespoke, probabilistic classifiers 302, executed on the data processing stage, are used to process each retrieved content item 202.

For example, image recognition techniques may be applied by at least one of the classifiers 302, to a content item 202 to determine one or more items of data related to the image data 204 contained in the content item 202. Image recognition techniques may identify, for example, logos or symbols. In another example, the colours in the image 204 may be identified to determine a colour palette. In some examples, the characteristics of one or more humans captured in the image 204 may be identified, e.g. age, sex, height, hair colour. Facial recognition techniques may also be used to determine sentiment characteristics, e.g. happiness, sadness, laughter.

In additional or alternative examples, natural language processing may be applied by at least one of the classifiers 302, to the content item 202 to determine one or more items of data related to the text data 206 contained in the content item 202. For example, user-entered words defined by a social user 112, such as “hashtags”, may be identified.

Similarly, corresponding classification techniques may be applied to the user data 208, engagement data 210 and metadata 212 contained in the content item 202.

For each item of data in the data set, each probabilistic classifier (labelled 302.1, 302.2 individually) outputs a probability vector (fingerprint) of the kind described above. The probability vectors are used to generate a multidimensional Euclidean vector which acts as a multidimensional feature vector 302. The total N classifiers 302 thus produce N probability vectors for each content item 202. In examples, a minimum of 1000 classifiers 302 are used. For example, a classifier may relate to the image data 204 in the content item 202. In this example, image recognition techniques applied to an image containing a motor vehicle may generate a classifier output pertaining to the make and/or model of the car. The number and type of classifiers will be specific to a particular content selection parameter, and hence the vector fingerprint 304 of the social data (i.e. content items) will be unique to that content selection parameter.

Each dimension of each feature vector thus corresponds to one of a set of predetermined criteria evaluated by the N classifiers for each content item (e.g. whether the content items contains a certain image structure, or expresses a certain sentiment etc.). For each feature vector dimension, an associated label is electronically stored, which identifies or indicates the corresponding criterion. It is thus possible to map each feature dimension back to the predetermined criterion to which it corresponds, via the dimension labels.

This is shown in FIG. 3, where each classifier 302.1, 302.2 is shown to produce a probability fingerprint 304 across all possible categories considered by the classifier. The N probability fingerprints 304 are then subject to vector concatenation by a concatenation component 306 to create a final n-dimensional vector 308. For example, the minimum number of dimensions for a social media post (or content item) may be one thousand. However, this system may scale to a greater number of dimensions, subject to computational resources of the system. Note, n (the number of dimensions) can be greater than N (the number of classifiers), as the probability vector output by a classifier can itself be multidimensional.

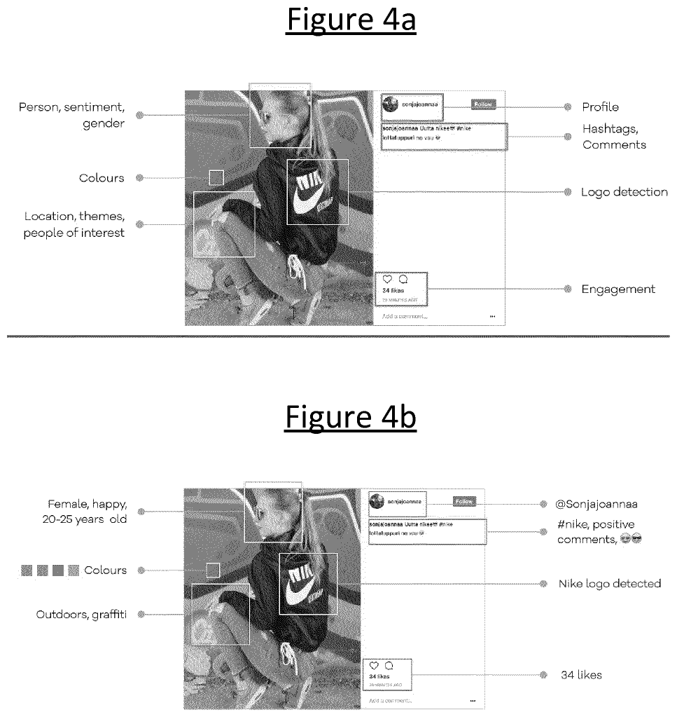

FIG. 4a shows an example content item 400 retrieved from a social media platform (e.g. Instagram). As shown, the content item contains various content, including sentiment data, gender data, colour data, profile data, text in the form of hashtags and comments, engagement data and images.

FIG. 4b shows an example of the information that can be extracted from the retrieved content item 400 using the analytic processed described herein. For example, using image recognition techniques the person in the image is determined to be a female between the ages of 20 and 25 with a happy sentiment. The dominant colours may also be determined, along with brand names and logos. Natural language processing may be applied to determine the social user name, hashtags and comments. Additionally, in this example the engagement data in the form of “likes” is determined.

Across a set of content items to be analysed, each of the corresponding n-dimensional vectors 308 is mapped into a graph of the same dimensionality as the n-dimensional vector 308. Following this mapping, the n-dimensional space is multiplied through a reduction matrix that collapses the size of any given dimension. The reduction matrix reduces the importance (dominance) of the distance metrics in the specific dimensions. For example if the transformation in a given dimension is zero then that dimension will become irrelevant for further analysis (e.g. that dimension may be disregarded).

A clustering component 310 then applies cluster analysis to all points in the reduced highly multidimensional space to create clusters. For example, the cluster analysis may use Lloyd's Algorithm or k-means clustering. Clusters span multiple dimensions and each cluster may be dominant in different dimensions (see below). Dominant here refers to a dimension that contains the most number of related content items. For example, a dominant dimension may be one which 80% of the content items 202 contain, e.g. 80% of the collected social media posts contain a female, with sufficient high probability although the dominance may not be as high as 80% depending on the propensity of other correlated dimensions. That is, what constitutes “dominant” is content dependent, and the percentage required for a dominant dimension can depend on the propensity of other correlated dimensions.

The number of clusters is determined automatically through an iterative process whereby the size of each cluster is considered. The minimum number of clusters is set. For example, the minimum number of clusters may be set to be four, although this is a user-definable software parameter. Clusters that are large, e.g. containing over 50% of the collected content items, are automatically re-clustered ignoring the dominant dimension (i.e. that are dominant in that cluster, but not necessarily in other clusters) to provide more granular detail. For example, if a determined dimension is female, this dimension may be split into multiple dimensions defining different age groups, e.g. 21-30 year old female, 31-40 year old female, etc. The percentage defining a large cluster is a software parameter that may be user-defined.

In some examples, more than one dominant dimension may be ignored. In this example, clusters can be automatically re-clustered ignoring more than one dominant dimension. For example, if the cluster is “positive posts about dogs in parks”, wherein the dominant dimensions may be “positive posts”, “dogs” and “parks”, all three of those dimensions can be ignored on the next iteration. The label “positive posts about dogs in parks” may be retained as a top level label if desired, and new labels can be assigned to any new clusters identified in the next or subsequent iteration(s), which are likely to be more specific.

Clusters that are less than e.g. 5% (a user-definable software parameter) of the overall population are ignored. For example, if 5% of the collected content items 202 contain a building, the dimension being “building”, this dimension may be ignored.

A further process is applied whereby clusters are inspected and any irrelevant or uninteresting clusters can be dealt with. This process may be manual or automatic. For example, machine learning may be applied to determine if a cluster is irrelevant or uninteresting based on training data or pre-determined criteria. If the data is irrelevant (e.g. due to hashtag clashing, noisy data) then the vectors can be excluded prior to graph mapping. If the data is uninteresting, e.g. the tribe (or cluster) is known and further detail is required, then that dimension can be reduced.

The reduction matrix provides a convenient and efficient means of removing or suppressing feature vector dimensions. The reduction matrix is refined in an iterative process. On the first iteration, the reduction matrix does not suppress or remove any dimensions. On the next iteration, the reduction matrix is modified (possibly with a degree of manual oversight), to remove or suppress dimensions in the manner described above. The number of iterations performed can vary depending on the results. In general, it is expected that the iterative process will terminate when there are no excessively large clusters remaining (clusters with more than 50% of the feature vectors in the above example), and when all of the uninteresting or irrelevant clusters have been removed.

A processing component 312 processes the feature vectors, and/or the corresponding content items, in each cluster to extract information for analysis. This information can be used as part of the ongoing iterative process, to refine the reduction matrix for the next iteration. The information extracted for the final set of clusters, once the iterative process has completed, is used to generate a report that can be output to the content-selecting user.

Each cluster may be analysed to determine a label for the social tribe that defines the cluster. For example, a cluster containing many data points relating to both urban areas (e.g. buildings, graffiti, parks, cars) and exploring (e.g. trainers, backpacks, maps) may be labelled as an “urban explorers” cluster or social tribe. Further analysis may show demographics of the tribe, such as the sex, age, location and language of the people who have posted the content items relating to that cluster. In examples, the posting times or frequency within a given period may be determined, along with any content themes and associated content tags. For example, a content theme may relate to the most prevalent object in the images. Associated content tags may be, for example, the most prevalent text or hashtags that appear in the content items 202. Additional information, such as the social users 212 who post the highest number of retrieved content items 202 and the sentiment of the content items 202 may also be determined and presented.

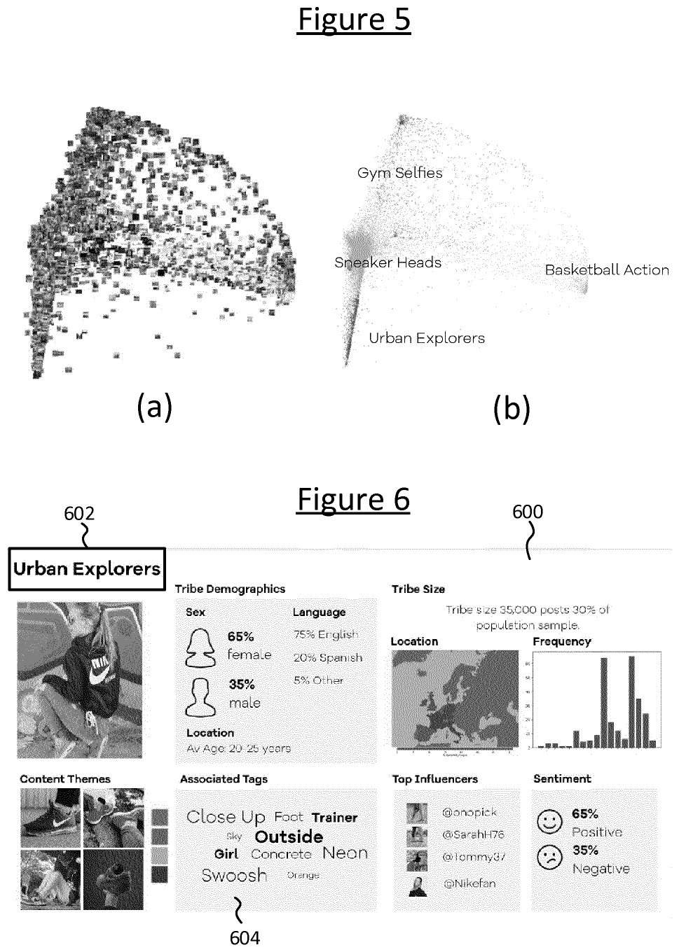

The data can be presented by performing PCA (principal component analysis) dimensionality decomposition on the high dimensional space to give a reference 2-dimensional graph. This will separate data into an arbitrary number of groups with an unspecified but real separation metric, which can be used to extract meaning from the larger data set. This allows large groups of data to be sorted and grouped when the best metric to group by is unknown or needs to be discovered. That is, to present the data in a form for an end user, the high dimensional data space can be subjected to a PCA-decomposition. This reduces dimensions of the graph dimensions while preserving the more prominent features. FIG. 5 shows an example of the result of the PCA decomposition where the n feature vector dimensions have been reduced to two dimensions to provide an intuitive representation of the social tribes.

The reduced dimensional graph can then be mapped, by the processing component 312, to two dimensions for visualisation of the clusters or to extract the meaningful distance between any given groups for further analysis. This is shown in FIG. 5, wherein the most dominant dimensions were determined as “Gym selfies”, “Sneaker Heads”, “Urban Explorers” and “Basketball Action”. If required, each dimensions can then be run through the process separately to create narrower dimensions. FIG. 5a shows the reduced dimensional graph wherein the data points are the constituent content items that make up the dimensions. FIG. 5b shows the reduced dimensional graph wherein each content item is mapped as a data point for visualisation purposes.

Advantageously, applying this process to data over time allows the automatic creation of insights into the social data that would not be possible by manual analysis. The large number of data points (e.g. content items 202) and dimensions combined with inherent human bias for spotting patterns that are interesting as occurring more frequently (e.g. the Baader-Meinhof Phenomenon) make this task impossible to carry out manually. With a combination of artificial intelligence and a clear process, undeniable patterns can be dynamically exposed in the data and tracked over time.

The ease at which specific dimensions can be ignored or data points removed automatically, using the reduction matrix, can be achieved efficiently using the described method. Furthermore, the process is scalable over very high numbers of dimensions, any types of data and for an unknown number of clusters, unlike existing methods that require a priori knowledge of the expected clusters.

FIG. 6 shows part of an example report generated by the processing component 312, based on the final set of clusters. The report shows information for one identified cluster, which corresponds to a social tribe identified via the cluster analysis.

The processing component 312 automatically derives a name 312 for the social tribe, as well as a set of associated “tags” 604. Both the name 602 (label) and the tags 604 are determined by identifying a set of the most dominant dimensions for the feature vectors in that cluster. As noted above, different clusters may be dominant in different dimensions; that is to say, different feature vector dimensions may be dominant in different clusters. These dominant dimensions can be used to infer a significant amount of useful information from the clusters, and the differences in the dominant dimensions between different clusters can be used to distinguish different characteristics of those clusters. For example, it is the dominant feature vector dimensions that are used to determine both the tags 604 and the label 602.

In the simplest case, a set of the M most-dominant dimensions is identified for the cluster in question, and a respective tag is provided for each of the M dominant dimensions in the report 600 for that cluster. Each tag can for example be the label associated with that dimension, or the tag can be derived from that dimension label using suitable processing.

The cluster label 604 is preferably derived by combining two or more of the labels of two or more of the dominant dimensions. The tags can be converted to an appropriate cluster label 602, where appropriate to provide a more intuitive cluster label, using one or more predetermined rules, which can for example form part of a language library.

For example, the labels from multiple dominant dimension tags are combined to find a two or three word description for a cluster. Similar tags can be grouped together, e.g. “person, human, people” into e.g. “people” and the top results are iterated to find an “adjective-noun” combination or “noun and noun” combination to dynamically describe the cluster. A language library can be used to refine a label automatically, to ensure it is meaningful to a human.

An example social tribe will now be described in more detail with reference to FIG. 6. As discussed above, an example social tribe may be “Urban Explorers”. The name of the social tribe may be determined, as described above, the content items that form the respective dominant dimension. In an example, the name may be determined using image recognition techniques, e.g. the majority of images within a respective dominant dimension are related to urban exploring activities. In another example, the name may be determined from dimension's associated tags (e.g. hashtags) or comments. In this example, the most prevalent tags in the dimension may have been, or synonymous with, “urban” and “explorers”.

A pre-determined number of the next most prevalent associated tags in the dimension may also be presented to the content selecting user 102. This way the user 102 is given an extra insight into the most popular or prevalent hashtags, user comments or image content. In examples, the size of the tag can be automatically set to indicate the respective popularity of the tag, e.g. the larger the tag, the more the tag was used. Brand name variations and grammatical conjunctions may be automatically removed.

The social tribe can be presented to the content selecting user 102 along with information classifying the social tribe. For example, images indicative of the content theme may be presented. In some examples, the images chosen to represent the content theme may be those with the greatest engagement levels, e.g. shares, likes, retweets and comments.

The tribe demographics can also be automatically determined and presented to the content selecting user 102. For example, the content items can be analysed to determine the percentage of male and female social users, along with their average age and the language used. For example, the Urban Explorers social tribe of FIG. 6 consists of content items of which 65% were posted by females with an average age of 20 to 25 years old.

Location data may be acquired by e.g. geo-tagging, region declaration and text-language analysis to determine a heat map showing the amount of content items collected from users in each country.

The frequency of content items may also be determined. For example, a graph may be automatically generated which shows the number of content items published to a social media platform per day, week, month or any other pre-determined time period. In some examples, the frequency may also show the number of contents published in each language per time period.

The top influencers can be automatically determined from the analysed content items. For example, a top influencer may be a social user who has the largest number of followers. On social media platforms, a social user's follower is another social user who is subscribed to view, receive or interact with the (followed) social user's published content items. This may involve, for example, receiving notifications when the social user publishes new content.

In another example, top influencers may be the social users who publish the most content items in the cluster. In yet another example, top influencers may be the social users who have received the most positive engagement on their content items from other social users.

Preferably, a score is generated for each social user whose content item(s) form the cluster. The score may be determined from number of content items, the level of engagement (e.g. number of likes, shares etc.), and/or number of followers for a particular user. The top influencers may then be the social users with the highest scores.

In examples, the number of top influencers may be user defined.

Whilst the invention has be described in relation to content items collected from content publication platforms (e.g. social media platforms), the techniques described herein are equally applicable to data sets that are not published on social media platforms or even the internet. For example, the techniques described herein can be applied to any provided data sets, including text only data sets and number only data sets.

The content processing system 100, content selection interface 104, content selection component 108, content retrieving component 118, content database 120, pre-processing component 122, concatenation component 306, clustering component 310 and processing component 312 may be implemented in the form of software stored in memory and arranged for execution on a processor (the memory on which the software is stored comprising one or more memory units employing one or more storage media, e.g. EEPROM or a magnetic drive, and the processor on which the software is run comprising one or more processing units).

For example, the plurality of multidimensional feature vectors 302 may be produced in parallel using one or more processors. Alternatively, the plurality of feature vectors 302 may be produced using a single processor. The plurality of probability fingerprints 304 generated from the plurality of feature vectors 302 may then be concatenated using one or more processors to create the n-dimensional vector 308. Similarly, one or more processors may be used to generate the clusters from the n-dimensional vector 308.

Alternatively it is not excluded that some or all of the system 100 and or described components could be implemented in dedicated hardware circuitry, or configurable or reconfigurable hardware circuitry such as a PGA or FPGA. Alternatively the system 100 and components could, partially or wholly, be implemented externally such as on a server or servers at one or more geographic sites (not shown).

The above embodiments have been described only by way of example. Other variations and applications of the present invention will be apparent to the person skilled in the art in view of the disclosure given herein. The scope of invention is not defined or limited by the described embodiments, but only by the appendant claims.

1. A computer-implemented method of processing content items to extract information for analysis, the method comprising implementing, at a data processing stage, the following steps:
receiving the content items to be processed, wherein a plurality of probabilistic classifiers is executed at the data processing stage for analyzing the content items in relation to a plurality of predetermined criteria;
processing each of the content items, by the probabilistic classifiers, so as to generate a corresponding multidimensional feature vector, wherein each dimension of the feature vector corresponds to one of the predetermined criteria and has a value, determined by one of the probabilistic classifiers, which denotes a probability that the content item meets that criterion;
applying cluster analysis to the multidimensional feature vectors at the data processing stage to identify a plurality of clusters of the multidimensional feature vectors; and
extracting, for analysis, information about each of the clusters from at least one of the feature vectors in that cluster and/or the content item to which it corresponds.

2. The method of claim 1, wherein the step of applying the cluster analysis comprises:
applying a clustering algorithm executed at the data processing stage to the feature vectors to identify an initial set of clusters of the feature vectors;
for at least a first cluster of the initial set of clusters, identifying at least one dominant dimension of the feature vectors in the first cluster; and
re-applying the clustering algorithm to the feature vectors in the first cluster, with the at least one dominant dimension suppressed or removed, to identify at least two sub-clusters of the feature vectors in the first cluster;
wherein the extracted information comprises information about at least one of the sub-clusters extracted from at least one feature vector in the sub-cluster and/or the content item to which it corresponds.

3. The method of claim 2, wherein the steps of identifying the at least one dominant dimension and re-applying the clustering algorithm are performed in response to determining that the number of feature vectors in the first cluster exceeds a maximum threshold.

4. The method of claim 3, wherein the maximum threshold is determined as a percentage of the total number of feature vectors to which the cluster analysis is applied.

5-28. (canceled)
